(19) United States
(12) Patent Application Publication
(10) Pub. No.: US 2007/0283389 A1
(43) Pub. Date: Dec. 6, 2007

(54) Method and system for helping operate a media-playing set

(75) Inventor: Bryan Severt Hallberg, Vancouver, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/444,639

(22) Filed: Jun. 1, 2006

(51) Int. Cl. G06F 3/00; G06F 13/00; H04N 5/445

(52) U.S. Cl. 725/37; 725/38

(57) ABSTRACT

A first exemplary method for helping a user operate a media-playing set using a control device, preferably a handheld remote, includes providing a remote support site from which at least one representative can remotely configure the set and, as the representative remotely makes different entries, highlighting the corresponding entry items on an image of the control device locally displayed on the set. A second exemplary method and system for helping operate such a set in which a readily expandible and updateable central database is provided at the remote support site for networked connection with the set and upon simple selection of a single help function included on the control device, an extensive and up-to-date explanation of how a selected control item of interest, such as an entry button or on-screen menu item, operates is retrieved from the database and promptly displayed by the set.

### CROSS-REFERENCE TO RELATED APPLICATIONS

Not applicable.

### BACKGROUND OF THE INVENTION

The present invention relates to a system for helping a user operate a media-playing set, such as a digital television set and peripherals, and, in particular, for helping the user operate the set by effective use of one or more control devices, such as a handheld remote control.

As technology has progressed, media-playing equipment has evolved into increasingly sophisticated and complex forms. For example, television sets, which used to provide a few buttons for turning the set On and Off and for switching between one of the four or five stations available, have evolved into hybrid entertainment systems. In one version of the modern set, a digital television receives a variety of input signals such as supplied, for example, from a videocassette recorder (VCR), digital video disc (DVD) player, compact disc (CD) player, game console, camcorder, personal computer, broadcast antenna, cable television link, or satellite dish. Hundreds of channels may be available to select between, such as in the case of a satellite broadcast. Not only is the television able to process and display each signal type, the computing power inherent in the television's processors enables the manufacturer to provide a feature-rich environment so as to allow the user, for example, to flexibly adjust the picture, audio, and selected setup or option features. Adjustable picture features, for example, can include brightness, backlight, contrast, color, tint, and sharpness; adjustable audio features can include treble, bass, balance, and Dolby ™ surround sound; and adjustable setup or option features can include channel setup, speaker setup, parental control, closed captioning, sleep, power conserve, or screen tilt. To conveniently adjust these various features, it is customary to provide a handheld remote control device having suitable buttons identified with these functions and typically having different modes, such as a mode for controlling the television and other modes for controlling different ones of the connected peripherals.

To some extent, the richness of features provided by manufacturers of media-playing sets is constrained not so much by technological limits as by the amount of information that can be readily imparted to users of the sets. Though information on how to use the remote control device to implement each function is typically available in a published manual, frequently the user either cannot locate the manual when needed or would rather not bother flipping through the manual in an attempt to locate the relevant information. If the information is located, the user has no recourse if the user finds the information difficult to understand or unintelligible. Such occasions lead many users to place a telephone call to the manufacturer's customer support line for help. However, the costs of staffing such a support center results in ongoing and prohibitive expense for the manufacturer, and in the interests of economy and providing better service to users, a better approach for helping users realize the full functionality of their sets using their remote control devices is desirably sought.

### BRIEF SUMMARY OF THE INVENTION

In accordance with a first aspect of the present invention, a method for helping a user operate a media-playing set using a control device is provided including the steps of providing a support site for supporting the user and other users, the site being located remotely from and selectively connectible electronically to the respective set of each user and being staffed by at least one representative; as said representative is helping the user, displaying an on-screen image representing the control device on the set; and as said representative remotely makes different entries for configuring the set, highlighting the respective entry items on said image corresponding to said entries remotely made by said representative. This procedure enables the representative, as they are configuring the user's set, to simultaneously coach the user on how to operate the control device him or herself to obtain the desired feature. The user can see the precise entries needed to obtain the feature and, provided the representative also explains to the user what they are doing, the user takes in this information both auditorily and visually and so has a higher probability of retaining this information. This, in turn, will reduce the future volume of calls to the support site and reduce the manufacturer's expenses of operating the site.

In accordance with a second aspect of the present invention, a system for helping a user operate a media-playing set using a control device is provided that includes a support site for supporting the user and other users, the support site being located remotely from and selectively connectible electronically to the respective set of each user and including a central database, the control device including a help function configured so that, upon user selection of the help function, an explanation on how a selected entry item of interest operates is retrieved from the central database and displayed by the set. This system enables the user to readily request, whenever desired, an explanation on how an unfamiliar entry item operates and, moreover, because the explanation is provided from information retrieved from a central database, the superior memory capacity of the remote database as compared to what can be stored locally enables a fuller explanation to be provided for each unfamiliar entry item so that the user is less likely to be confused than if the explanation were in a more terse and cryptic form.

In accordance with a third aspect of the present invention, a method for helping a user operate a media-playing set using a control device is provided including the steps of providing a support site for supporting the user and other users, the site being located remotely from and selectively connectible electronically to the respective set of each user and including a central database; providing a help function on the control device and, upon user selection of the help function, retrieving an explanation from the central database on how a selected entry item of interest operates and displaying the explanation on the set. As with the aspect described immediately above, this procedure enables the user to readily request, whenever desired, detailed information about an unfamiliar entry item. It will be noted that providing enhanced memory capacity at a central database is more economical than trying to equip each set with enhanced memory resources. Also, by centralizing the database containing the desired information, this information can be readily updated so that if, for example, a large number of user inquiries are received indicating that users are having difficulty with a particular entry item, the corresponding explanation for that item is easily revised to a form better suited for ready user comprehension. This, in turn, reduces the volume of calls received by the support site and lower the costs of operating the site.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a diagrammatic view of an exemplary system for helping a user operate a media-playing set using a control device in accordance with the present invention.

FIG. 2 is a schematic view showing details of the system of FIG. 1.

FIGS. 3A-3D are a plan view of an exemplary handheld remote control constructed in accordance with the present invention.

FIG. 4 is a flowchart outlining a first exemplary method for helping a user operate a media-playing set using one or more control devices.

FIG. 5 is a plan view of the on-screen display of the digital television of FIG. 2 during operation in accordance with the first exemplary method of FIG. 4.

FIG. 6 is a flowchart outlining a second exemplary method for helping a user operate a media-playing set using one or more control devices.

FIG. 7 is a plan view of the on-screen display of the digital television of FIG. 2 during operation in accordance with the second exemplary method of FIG. 6 after the HELP function on the handheld remote control of FIG. 3 has been selected.

FIG. 8 is a plan view of the on-screen display of the digital television of FIG. 2 during operation in accordance with the second exemplary method of FIG. 6 after the entry item of interest has been selected by pressing the EDIT button on the handheld remote control of FIG. 3.

FIG. 9 is a plan view of the on-screen display of the digital television of FIG. 2 during operation in accordance with the second exemplary method of FIG. 6 after the entry item of interest has been selected by choosing the Auto Sync on-screen menu item.

### DETAILED DESCRIPTION OF PREFERRED EMBODIMENT

### I. System Architecture

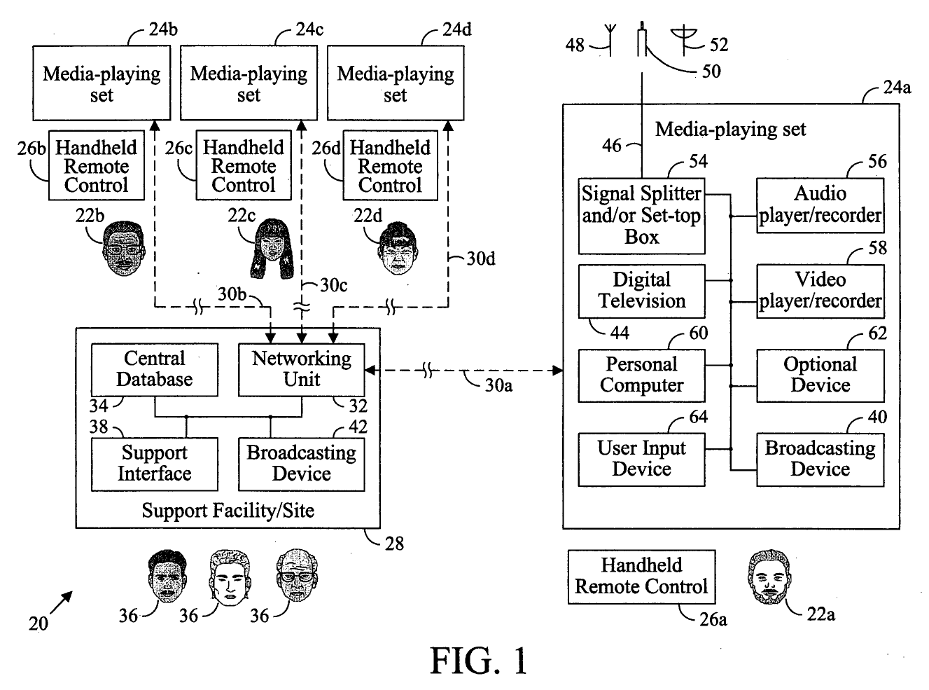

FIG. 1 shows, in functional block-diagram form, an exemplary system 20 constructed in accordance with the present invention for helping end users 22a-d operate their respective media-playing set 24a-d using one or more control devices, such as a handheld remote control 26a-d. A support facility or site 28 is provided to offer support to each user in operating their set. This site is located remotely from each set, where the term “remotely” in this context, as used herein and in the claims, is intended to denote that the site is not physically accessible to any user in the home or quarters where the set is located.

To enable each user to access the resources provided by the remote site 28, each media-playing set 24a-d is selectively connectible electronically to the remote site over a temporary network connection which can be established, for example, over conventional telephone lines. In FIG. 1, each network link 30a-d is depicted in dashed-line view to indicate this temporary connection. Preferably a secure connection standard is used, such as Secure Sockets Layer (SSL) technology, to prevent anyone from eavesdropping on a respective user's viewing habits. A modem communications language is desirably employed, such as Extensible Markup Language (XML), that is readily readable by the set using a conventional web browsing application.

The remote site 28 includes a networking unit 32 capable of remotely detecting the status of each set 24a-d and remotely driving or controlling the set's operation. The remote site further includes a central database 34 which, among other things, stores detailed instructions explaining how to effectively operate each control device, which instructions may vary depending on the model type of the corresponding set 24a-d.

In accordance with at least one aspect of the present invention, the remote support site 28 is staffed by customer support representatives 36 who interact with the networking unit 32 through a support interface 38, such as a computer terminal providing a mouse and keyboard, from which they can remotely check the status of and remotely control the operation of each connected set 24a-d. In the preferred embodiment shown, the support site is a call-in center so that representatives initially receive inquiries from users via telephone; however, alternative modes of communication between users and representatives can be employed, such as through videoconferencing or chatroom technology. Each set includes a broadcasting device 40, such as a display screen and speakers, and desirably a comparable broadcasting unit 42 is provided at the remote site that replicates the visual and audio output of each local broadcasting device so that representatives are able to see the images and hear the sounds broadcast from each set exactly as they are heard and seen by each user. The speakers are detachably mounted on the set as a left/right pair and the set also includes four audio terminals for optionally connecting a set of four stand-alone speakers to provide enhanced surround-sound capability. Alternatively, a representation of the customer's TV image could be displayed on the remote PC, in order to allow the customer service representative to use a smaller amount of equipment. Also, the exact video viewed by the customer need not be shown on the PC, as this would require a large amount of communication bandwidth between the TV and the remote PC, but add little functionality.

As shown in FIG. 1, each media-playing set 24a , b, c, or d, hereafter identified by generic item number 24, is typically comprised of various components separately available commercially. At the heart of the exemplary media-playing set depicted is a digital television 44, although some other suitable audiovisual receiver, such as a computer provided with a television tuning card, an audio receiver, a camcorder, a still camera, or some other consumer electronics product could assume this role. For the set depicted, an external feed 46 connects the television to an air antenna 48, cable link 50, and/or satellite dish 52 by way of a signal splitter and/or set-top box 54 so that multiple input signals are simultaneously presented to the television. These include a decrypted cable or satellite signal (hereinafter referred to as the “Antenna A” signal), an air antenna signal (hereinafter referred to as the “Antenna B” signal), and a digital signal as customarily used to carry both standard- and high-definition programming. A set-top box can be used to decrypt and decode the digital signal or, alternatively, an on-board converter can be used, such as a CableCard™ which decrypts video mateably received into a slot in the digital television which decodes video may be provided for that purpose.

The television 44 also receives input signals that originate from the other components of the set. These can include, for example, an audio signal from an audio player/recorder 56, such as a compact disc (CD) player; a combined video/audio signal from a video player/recorder 58, such as a combined video cassette recorder (VCR) and digital video disc (DVD) player; and a digital video interface (DVI) input/control signal from a personal computer 60. Other signals may be provided from one or more optional devices 62, such as a game console, a camcorder, a high-definition media interface (HDMI) device, and a digital videorecorder home system (D-VHS), hereinafter referred to as the “iLink” device. In addition, a memory card adapter (not shown) is installed on the television for receiving a memory card and compatible memory stick in order to provide on-board access to recordable and playable media.

The user is able to control the television 44 through either the handheld remote control 26a, the input keyboard and mouse of the personal computer 60 or through some other user input device 64 such as an RS-232C connection or a panel of buttons on the console of the television. These devices are hereafter collectively referred to as “control devices,” which term, as used herein and in the claims, is intended to signify any device that can provide a control (not just signal) input to the television or other set receiver. Depending on which type of control device is used, different levels of functionality are available. For example, only a limited number of functions are available using the panel of buttons on the television's console due to their limited number in comparison, for example, to the number of buttons on the handheld remote control. This is even clearer when considering that some control buttons on the handheld remote perform more than one function depending on which order the buttons are pressed. Moreover, the functions available change somewhat when the personal computer 60 is selected as the input source instead of one of the other components. For example, under the setup menu, an extra “Auto Sync” function is available when the input source chosen is the personal computer in order to enable the clock rate and phase of the picture signals of the computer 60 and television 44 to be synchronized with each other. From this, it should be apparent that in using either a handheld remote control or personal computer to control the set, that is, in selecting a desired one of the various input signals, in adjusting the set for best displaying the signal, and in operating the source component to control the type of programming provided to the set, the precise button or menu entry sequence needed can become somewhat involved and difficult to remember unless extra guidance is provided. This guidance is effectively offered in accordance with the present invention by means of the two exemplary methods further described under separate Roman numeral heading below.

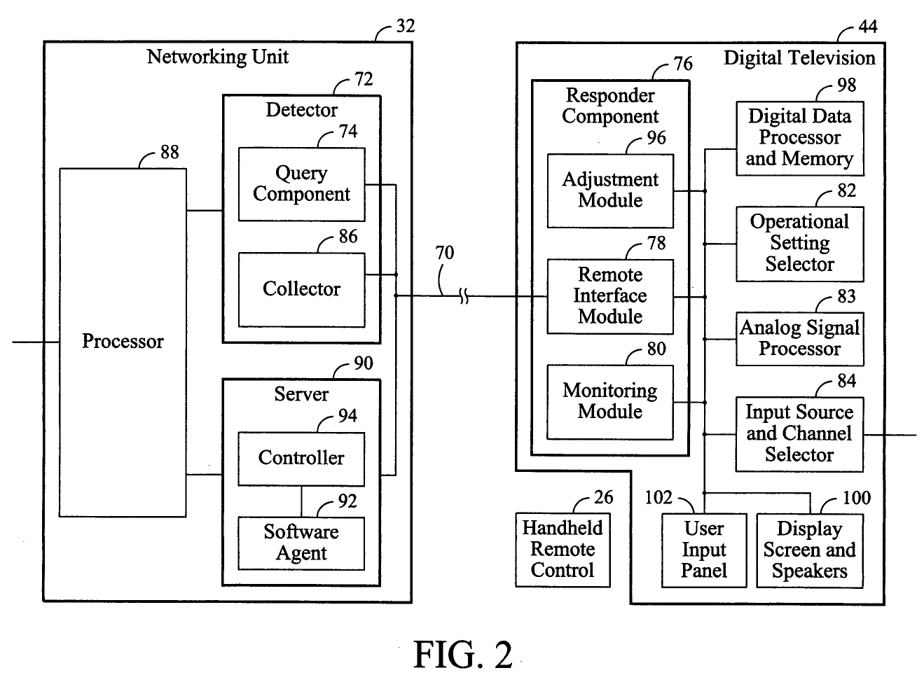

FIG. 2 depicts, in schematic form, certain functional components of the remote networking unit 32 and digital computer 44 as selectively connected together via a network link 70. The networking unit includes a detector 72 having a query component 74 for remotely requesting status information from a responder component 76 of the set. In particular, the query is directed by the remote interface module 78 of the responder component to the monitoring module 80. The monitoring module detects the current operational settings (such as the picture, sound, power, setup, option, and digital setup values) made at the operational setting selector 82 and the current program settings (input source and channel selection) made at the input source and channel selector 84. This information is conveyed back to the interface module where it is relayed back to the remote collector 86.

A processor 88 interprets the status information collected. Thus, if the information includes a request for an explanation on how to operate a particular entry item of one of the control devices, the processor automatically retrieves the relevant section of explanation from the central database 34 (FIG. 1) and passes this information to the remote server 90. A software agent 92 and controller 94 included in the server then convey suitable command signals to the set so that the set will display the retrieved explanation. The command signals are relayed by the remote interface module 78 to the adjustment module 96 which directs the digital data processor and memory 98 to render the explanation for display on the screen portion of the display screen and speakers 100.

In like fashion, a support representative 36 (FIG. 1) can assume control over the operation of the set. For example, if the user requests help making a brightness adjustment, the representative, by making the appropriate entries at the support interface 38, causes the remote server 90 to issue the necessary control signals, which signals are relayed to the adjustment module 96, which then directs the operational setting selector 82 to make the necessary adjustments. Of course, typically the set is controlled locally by the user using one of the control devices provided, here including the handheld remote control 26, the user input panel 102 on the television's console, or the personal computer 60 (FIG. 1). Desirably, the user is able to perform the full range of functions available to the representative to enable the user to develop an appreciation for the advanced features available on the manufacturer's higher-end models. Conversely, it is desirable that the representative be able to perform the full range of functions available to the user so that the representative can remotely make whatever adjustments are needed at the set.

The digital television 44 further includes an analog signal processor 104 for demodulating and processing the analog signals (Antenna-A and -B) input to the television. The digital data processor and memory 98 demodulates, decodes, and processes the digital signal input. It will be noted, in connection with both FIGS. 1 and 2, that the functional components shown are so depicted for ease of illustration and description and that these components can be combined or divided differently than shown without substantially departing from at least the broader aspects of the present invention.

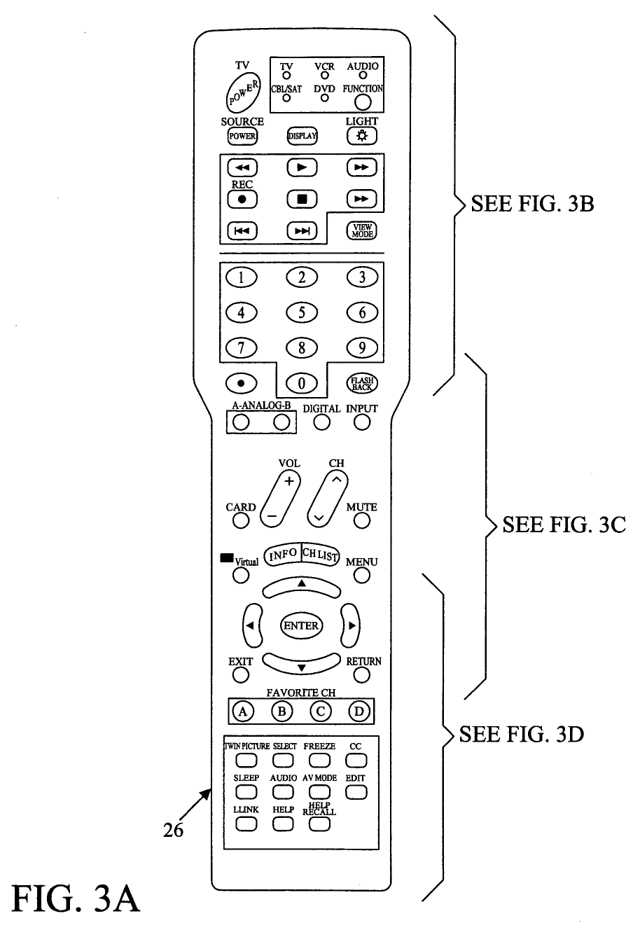

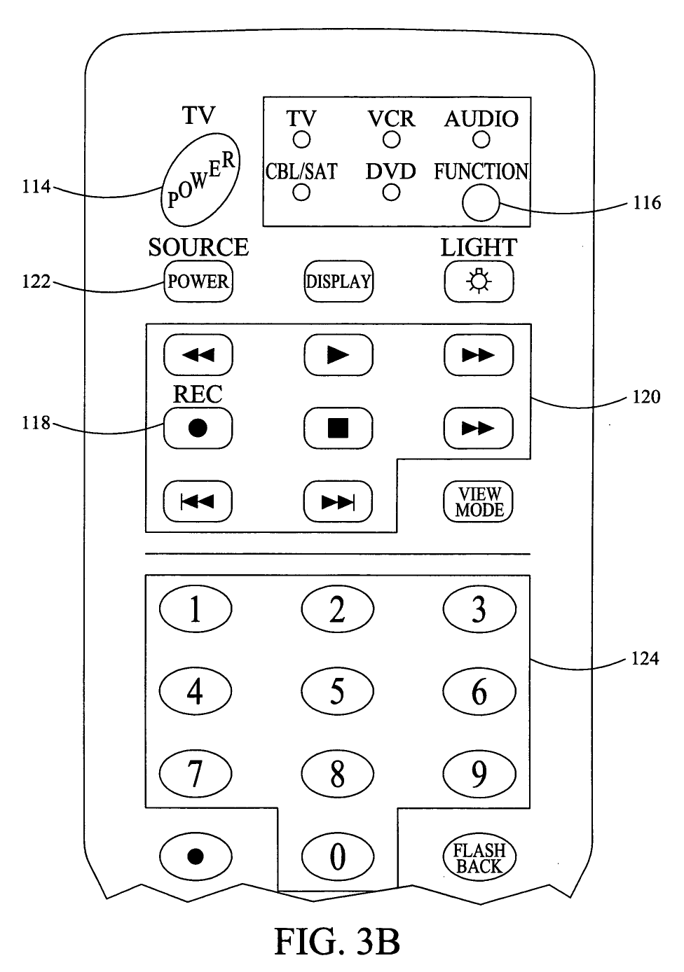

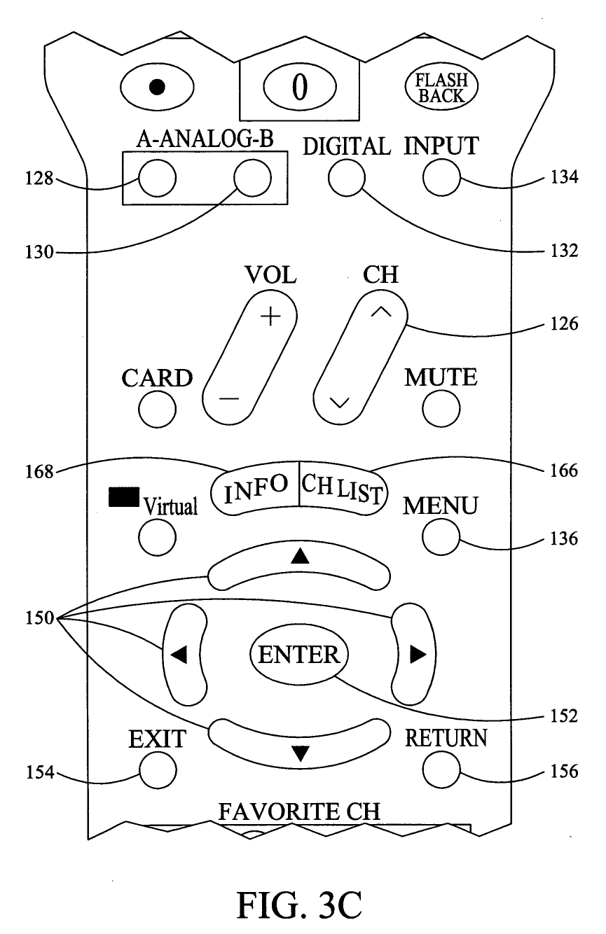

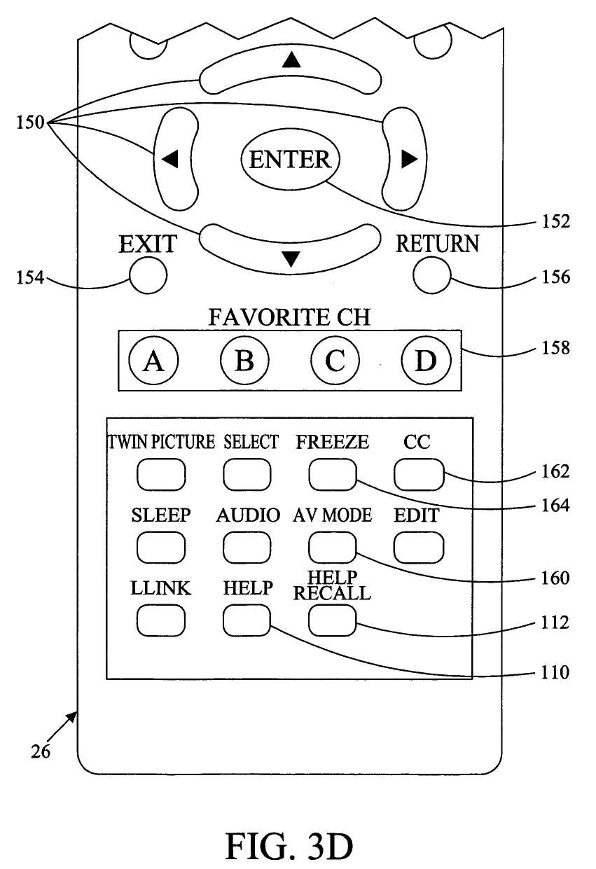

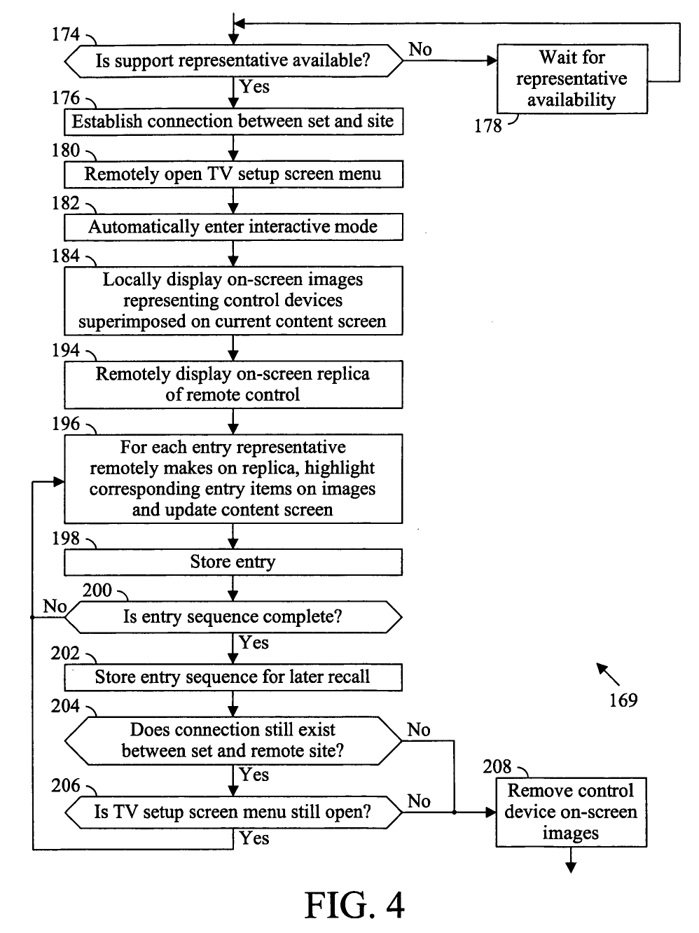

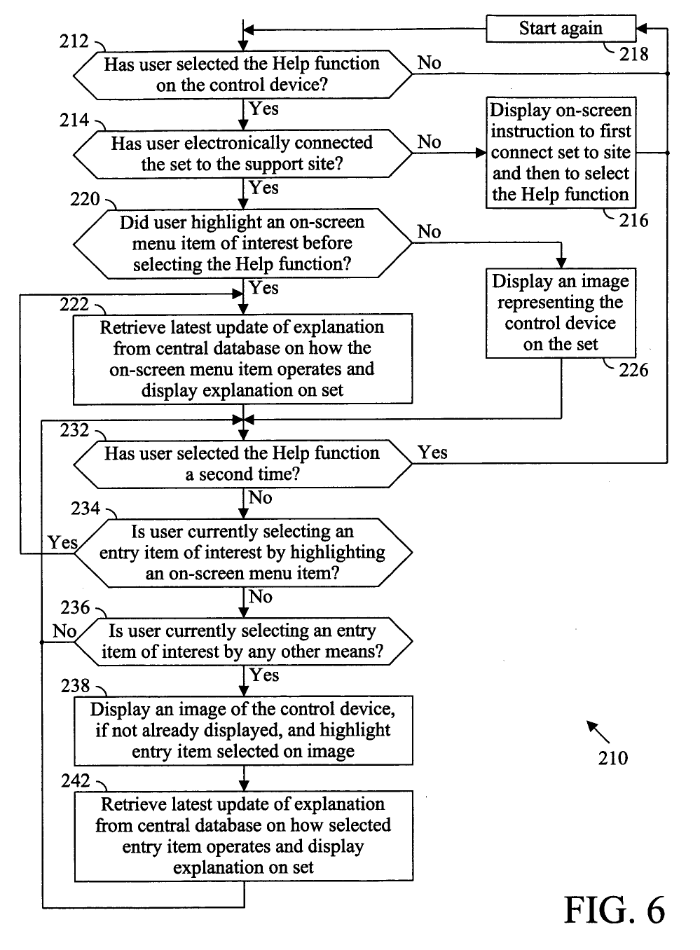

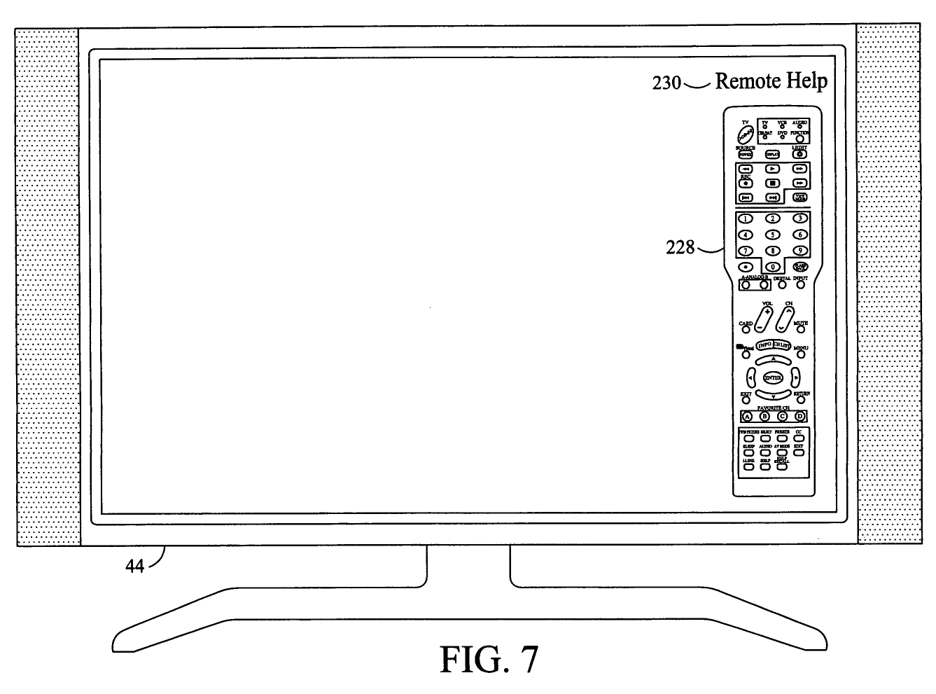

FIG. 3 shows an exemplary handheld remote control 26 constructed in accordance with the present invention. As indicated above, this is one type of “control device,” another type being, for example, the personal computer 60 (FIG. 1). On the remote control, a Help function or entry button 110 is provided. This Help function, when selected or pressed, causes a detailed explanation to be retrieved from the central database 34 (FIG. 1) and displayed either on how to operate another selected entry button or a selected on-screen menu item. This procedure is further described in connection with FIG. 6. Desirably, the remote control also includes a Help Recall function or entry button 112 that, when pressed by the user, calls up any entry sequences stored during a previous Help session with the customer service representative, as further described in connection with FIG. 4. If the control device is a personal computer as opposed to a remote control, the Help or Help Recall functions would typically be operated by clicking on an input mouse so as to select either a Help or Help Recall menu item. Again, either an explanation of the entry item selected or any entry sequences stored is retrieved depending on which of these two functions is selected.

The remainder of the functions or entry buttons on the remote control 26 may be broadly categorized as being of conventional character. Notwithstanding this classification, an overview of their operation will now be provided as they reflect the range of functions that a modern control device can provide, and this overview will underscore the desirability of providing a detailed explanation enabling the user to keep track of the various functions.

The Power entry button 114 switches the television between Standby and Active modes (a Power button on the user input panel 102 (FIG. 2) is used to originally turn the power On). By pressing the Function entry button 116 repeatedly, the user can cycle between controlling different components, with the current selection being indicated by a lit display. That is, referring also to FIG. 2, the user can choose between using the handheld remote control 26 to control the television 44 (TV), the cable or satellite set-top box 54 (CBL/SAT), the videocassette recorder portion of the videoplayer 58 (VCR), the digital video disc portion of the videoplayer 58 (DVD) or the audioplayer/compact disc player 56 (AUDIO). With this cycling between control modes, a single entry button on the remote control can be assigned more than function so as to conserve physical area. For example, pressing the Record (REC) button 118 can cause the television (with a memory card and stick installed), the VCR, the DVD, or the audioplayer to start recording depending on which component is currently selected. If the Function button is held down for three seconds, the user can enter the manufacturer's code for the selected component in order to ensure remote control compatibility with that component.

The Record (REC) button 118 is one of a first set of buttons 120 (fast rewind, play, fast forward, record, stop, pause, go to beginning or end) generally used for operating the peripheral components together with the source Power On/Off button 122. A second set of buttons 124 for individually inputting channel numbers and a rocker-arm style channel button 126 can be used to switch channels on either the television or, possibly, a peripheral component depending on the component type. The programming content currently displayed by the television is controlled by pressing one of four signal input buttons: either the A-Analog button 128 (for the A antenna input corresponding for example, to a cable/satellite broadcast), the B-Analog button 130 (for the B antenna input corresponding, for example, to an air antenna broadcast), the Digital button 132 (corresponding to a standard- or high-definition digital broadcast), and the Input button 134 which, when pressed repeatedly, cycles between TV input (in turn defaulting to one of the three buttons above), input 1 (e.g., from the DVD), input 2 (e.g., from the VCR), input 3 (e.g., from an optional device 62 such as a game console or camcorder), input 4 (e.g., from an HDMI component), input 5 (e.g., from the personal computer 60), iLink (e.g., from a digital videocassette home system or D-VHS), or card (e.g., from a memory card and stick installed on the television.

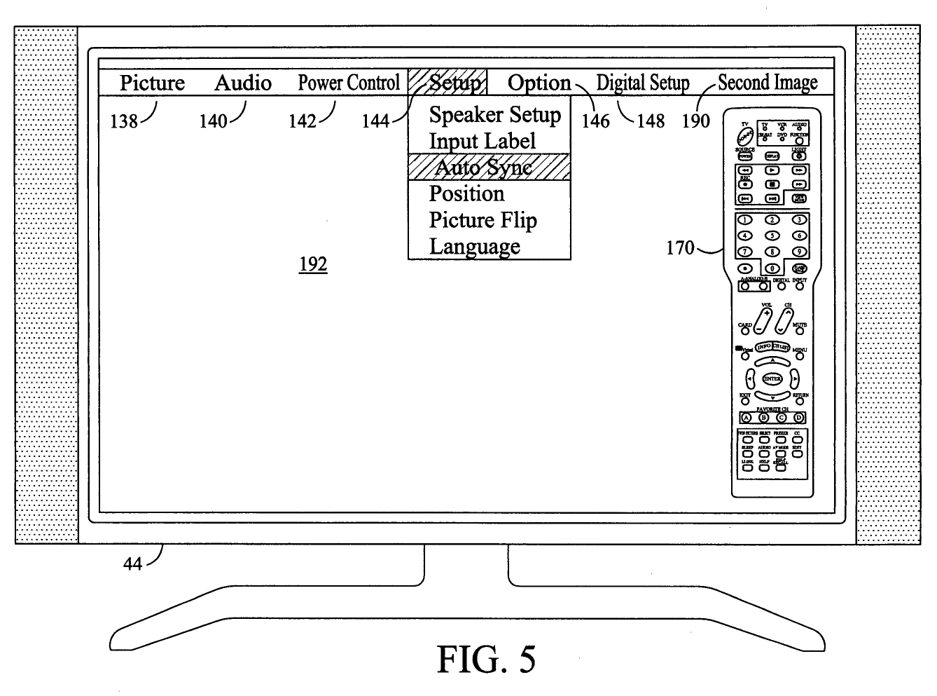

In order to ensure proper interaction between the television 44 and each type of peripheral component available and to adjust the picture and sound for each of the various signal types receivable, the remote control 26 (and, for that matter, the personal computer 60) provides a Menu function or entry item 136. By selecting or pressing this function, the user calls up an on-screen menu on the television which, as shown in FIG. 5, includes the following menu headings: Picture 138 (including drop-down menu items such as optical picture control or OPC for automatic brightness adjustment, Backlight, Contrast, Manual Brightness, Color, Tint, Sharpness, and Advanced Color Management System or CMS); Audio 140 (including drop-down menu items such as Treble, Bass, Balance, and Dolby Virtual for surround sound); Power Control 142 (including selected drop-down items for automatically powering down to conserve energy if no signal or operation is detected for a given period); Setup 144 (including drop-down menu items such as Speaker setup, Input Label, Screen position, Picture Flip, Language, Auto Sync (in personal computer input mode only) and EZ setup and Parental Control (in other input mode only)); Option 146 (including drop-down menu items such as Input Select, which provides an on-screen entry item equivalent to the Input button 134 on the remote control, and miscellaneous setup items for various optional components); and Digital Setup 148 (including drop-down menu items such as iLinks—used to set up a D-VHS peripheral, Video, Audio, and CableCard—used to set up the CableCard™ converter installed in the television which decrypts digital signals). The menu items are navigated and selected using the navigational entry buttons 150 and the Enter entry button 152, which buttons also navigate through any menu provided by a peripheral component. An Exit button 154 and Return button 156 causes the menu to be exited and returned to the previous menu screen, respectively.

To briefly consider just a few other useful functions, the remote control further includes a third set of buttons 158 that can be programmed to enable one-touch entry of the user's four favorite channels and an audiovisual (AV) button 160 that enables the user to apply a predetermined audiovisual setting to the broadcast that is optimized for movie images, game images, personal computer images, and so on. There is also a closed captioning (CC) button 162, a freeze button 164 for capturing a still frame from a moving image, and Channel (CH) List and Information (INFO) buttons, 166 and 168, respectively, for calling up a list of digital channels available and for retrieving the station and show information typically broadcast with each digital channel segment. Although other control entry items and buttons are available via the remote control or personal computer, the above description should suffice to indicate the type and variety of functions available.

### II. First Exemplary Help Method with a View of Control Device

FIG. 4 is a flowchart depicting a first exemplary method 169 for helping a user operate a media-playing set using one or more control devices, such as a handheld remote control 26 (FIG. 3). It is intended that this method be practiced in the context of a system of the type shown and described in connection with FIGS. 1 and 2, that is, that a remote site 28 is provided for supporting the user 22a and other users 22b-d, that this site be selectively connectible electronically to the respective set of each user, as by network links 30a-d, that the support site be staffed by at least one representative 36, and that the site provide a mechanism, such as support interface 38, networking unit 32, and controller 94, enabling the representative to remotely make different entries for configuring the user's set.

Referring also to FIG. 5, in accordance with this first exemplary method 169, as the representative is helping the user, at least one on-screen image 170 representing at least one of the control devices is displayed on the television 44. Furthermore, as the representative remotely makes different entries for configuring the set, the entry items on the image corresponding to the entries remotely made by the representative are highlighted. For example, if the representative remotely selects the “Speaker Setup” menu item, such as by using an input mouse at a computer terminal, then the corresponding Enter entry button on image 170 (corresponding to item 152 in FIG. 3) is highlighted. This enables the user to see exactly, for future use, what entries are needed and to follow along, entry-by-entry, with the representative. Assuming also that the representative explains what he or she is doing as he or she proceeds, this in turn enables the user to follow the action taken by the representative both auditorily and visually and so to have a better chance of retaining the expert information imparted. Additional aspects associated with this first exemplary method are depicted in FIG. 4, which aspects will now be described.

Referring now to FIGS. 1 and 4, step 174 of the first exemplary method 169 includes determining if a support representative 36 is available and, if so, in accordance with step 176, establishing connection between the respective set and the support site 28. The order of these first two steps can be reversed; however, if the order depicted is followed, the representative is able to help the user establish connection if the user is having difficulty. If a representative is not available, as step 178 indicates, the user should wait before starting the method until such time as a representative is available.

In reference to step 176, connection can be established either directly between the support site and digital television 44 or, if the personal computer 60 is being used as an input/control device, through connecting the support site to an input port of the personal computer and then connecting an output port of the personal computer to the digital video interface (DVI) input/control port of the television. In the latter instance, preferably the network link 30a (or 30b , c, or d) constitutes a broadband connection, such as provided using digital subscriber line (DSL) technology over conventional telephone lines. Connection can then be initiated, preferably with secure protocols, using conventional dial-up and web browser tools, although the television can also be programmed to run a connection script upon startup either by software stored in resident memory or on removable media such as a compact disc (CD). Of course, these connections will vary if, instead of a television, other signal reception means is provided, such as a television tuner card installed in the computer itself.

Proceeding to step 180, the representative next remotely opens a TV setup item displayed on his or her screen menu. As indicated in step 182, this automatically causes the remote site 28 and media-playing set 24 to enter an “interactive mode” whereby the representative can remotely query and control the set's components including the television 44. Per step 184, this also desirably causes on-screen images representing one or more of the control devices to be automatically displayed locally in superimposed position on the current content screen. For example, referring to the television screenshot depicted in FIG. 5, a first on-screen image 170 of a control device, representing the handheld remote control 26 (FIG. 3) and depicting selectable entry buttons, and a second on-screen image 190 of a control device, representing the personal computer 60 and depicting selectable menu items, are simultaneously displayed in superimposed position on content screen 192. Skipping now to step 196, it will be noted that when the representative remotely makes an entry, both an entry button on the image representing the handheld remote control and a menu item on the image representing the personal computer are normally highlighted, that is, the user can follow the entries made for whichever type of control device, handheld remote or personal computer, the user prefers. Furthermore, with each entry, the content screen 192 is updated as appropriate (such as when adjusting the brightness level) so that the user can follow not only the entries on whichever control device is preferred but also immediately see their effect on the broadcast.

Referring also to step 194, preferably an on-screen replica of the remote control 26 is remotely displayed on the representative's broadcasting unit 42 (FIG. 1) and is designed for interactive operation by the representative such that, for example, by pointing and clicking with a mouse on the virtual buttons of the replica, the representative can remotely make entries to the set. In this manner, the representative can precisely control the sequence of entry buttons that are highlighted for the user on the local image 170 of the handheld remote since there is then an exact one-to-one correspondence established between the virtual button entries made by the representative and the entry buttons highlighted for the user on the local image. Any form of highlighting that is readily visible to the user can be used to flag each entry selected including differently coloring the entry relative to the other entries (such as by darkening or inverting the color), or outlining, enlarging, brightening, or flashing/blinking the entry.

It will be noted that the representative could, alternatively, remotely use an input mouse to directly select the menu items on the menu image 190. As noted above, menu image 190 represents the personal computer controls and is the same menu the user would work with if it was the user controlling the television via the personal computer. However, the resulting entry sequence would be somewhat less easy for the user to visually track. By using a replica of the remote control, the representative is forced to make each entry one easily followed step at a time. For example, rather than jumping instantly from one menu item to another in a seemingly random direction, which the representative could easily do when using a mouse, instead the representative is forced, when using the virtual navigational buttons of the replica, to move strictly horizontally or vertically one menu item at a time. Similarly, rather than one menu appearing at one instant and then, unaccountably, an entirely different menu appearing another, which would occur if the representative left-clicked a mouse to select a menu item, instead the representative is forced, when selecting a menu item using the virtual buttons of the replica, to hit the virtual Enter button, thereby making this otherwise invisible entry immediately visible to the user. In a sense, the menu image 190 is not only an input image representing the control inputs of the personal computer but also an output image representing the output of the handheld remote control operating with its Menu button active and the television's input source set to personal computer. Hence, like the updating of the content screen 192 described above, this is another instance of displaying both the entries made and their effect. To express it still another way, the functional qualities making the remote control a slower, more demanding, and less intuitive control device than the scrolling and clicking of the mouse of a personal computer are the same qualities which make its operation easier for the user to follow and remember.

Referring to steps 198, 200, and 202, each entry the representative makes is desirable stored, until the sequence that includes the entry is complete, at which time the entire entry sequence is desirably stored, as a unit, for later recall at the request of the user. For example, despite a prior session with a support representative that covered the issue, some days or months afterward, the user may have forgotten the sequence of keys needed to adjust the picture brightness. By pressing the Help Recall button 112 (FIG. 3) on the remote control 26 until this sequence appears, the user is then reminded of the sequence of entry buttons previously used to increase brightness (e.g., Menu, Enter on Picture option, Arrow Down ×4 and Enter on Brightness bar, Arrow Right ×5 and Enter on bar slider).

Referring to steps 204 and 208, if, at any time during a help session, connection between the remote site 28 and set 24 is broken, desirably the on-screen image 170 of the remote control is removed from the screen. This alerts the user that connection with the remote site has been lost. Referring to step 206, this image is also removed and the exemplary method 169 concluded when the representative remotely closes the TV setup item on his or her screen. Otherwise, as indicated in FIG. 4, the representative can continue making entries and so continue highlighting the corresponding entry items on the control device images until such time as the representative and user deem it advisable to quit this procedure.

### III. Second Exemplary Help Method with Network Lookup of Control Entry Items

FIG. 6 is a flowchart depicting a second exemplary method 210 and operational features of an exemplary system 20 for helping a user operate a media-playing set using one or more control devices. The basic architecture of the system is described above in connection with FIG. 1 and includes a remote support site 28 for supporting the user 22a and other users 22b-d, this site being located remotely from and selectively connectible electronically to the respective set of each user, as by network links 30a-d, and further including a central database 34. The control device, which can include a handheld remote control 26 (FIG. 3) or personal computer 60, includes a Help function which, upon user selection, causes an explanation of a selected entry item of interest to be retrieved from the central database and displayed on the set. Referring also to FIG. 2, preferably this retrieval can occur automatically, that is, a networking unit 32 at the remote site has a detector 72 configured to automatically detect any Help request, a processor 88 configured to automatically process the request, and a server 90 configured to remotely drive the local receiver or television 44 so that the explanation is automatically displayed on the screen 100 of the set.

Using the above approach, simply by selecting or invoking a single, readily identifiable Help function, the user can easily retrieve an explanation on how a specific but unfamiliar entry item operates without getting bogged down in over-generalized explanations and without having to remember non-intuitive entry methods for invoking Help, such as multiple or timed button entries. Furthermore, in storing the explanatory information on a central database 34 accessible to each local set via a network connection, several advantages are realized. These include reduced manufacturing cost because it is relatively less expensive to provide even relatively large memory resources on one central unit than much smaller memory resources on each of many thousands of distributed units. Also, because there is greater space to store the explanation associated with each entry item, a more detailed and thorough explanation of each entry item can be provided; indeed, the explanation can be made substantially as comprehensive in detail as the section in the set's instruction manual explaining that particular item's operation, even to the point of closely paraphrasing, substantially repeating, or even expanding on the exact wording used in the manual. The need for extensive memory resources to fully realize this objective becomes apparent when considering that the exemplary remote control shown in FIG. 3 includes over fifty individual entry items or buttons, with some of these buttons performing more than one function depending on the input source or function mode chosen (e.g., using Input button 134 or Function button 116). As the manual may, on average, devote a page or two to describing each function, the total amount of explanatory material stored in memory for just this one type of set will at least approach, if not exceed, one hundred pages; however, from the standpoint of the user, a detailed explanation concerning each entry item is clearly more advantageous than an overly terse and cryptic explanation. If desired, the explanation can be provided or supplemented in a form other than text, such as by using pictures, graphics, or tutorial videos, thereby requiring, of course, even greater memory resources.

Another advantage of storing the explanatory information on a central database 34 is that this information is then readily revised merely by updating the database, which updating process would be much more cumbersome and difficult were the information to be separately stored on each individual set selectively connectible to the network. The need for such revision may become apparent, for example, if the support site receives a lot of inquiries about a particular entry item, which may indicate that the currently available explanation for that item is confusing to users. Under the present system and method, by merely keeping the contents of the remote database current, the support staff ensures that each user is provided ready access to the most complete and up-to-date information about each entry item.

Further details concerning the second exemplary method 210 and related system are depicted in FIG. 6. Referring to that figure, initial step 212 involves determining if the user has selected the Help function on the control device. If not, the method is restarted; if so, the method continues. Referring also to FIG. 2, the monitoring module 80 repeatedly polls the other television components to determine what input entries, if any, the user has made. If the user has selected or activated the Help function or entry item, then, without more, the exemplary method commences. For example, referring to FIG. 3, the user can select the Help function simply by pressing the Help entry button 110 on the handheld remote control 26 normally in whatever fashion is most natural to the user without, for example, needing to count a predetermined number of seconds before release or without hastening to complete a further number of presses before a predetermined number of seconds have elapsed. Similarly, the user can select the Help function with the computer 60, for example, by using a mouse input of the personal computer to simply click on an on-screen Help menu item (it is assumed here that the personal computer is already connected to the television and has been selected as the input source—for further details, see the general description above concerning the Input button 134). In the following description relating to FIG. 6, given its ease of use and lack of any need to make it operable by further interconnections and setup adjustments, the handheld remote 60 is regarded as the preferred form of control device, although a personal computer or even some other type of input device could alternatively be used. The main point in this first step 212 of the exemplary method 210 is that the user is able to invoke or initiate the method with a single and intuitively obvious entry.

The next step 214 involves determining if the user has electrically connected the set 24 to the support site 28. In the exemplary system shown in FIG. 1, the user can, for example, establish a broadband dial-up connection, over conventional telephone lines, between the remote site 28 and the personal computer 60, and then connect the computer's output port to the digital video interface (DVI) input/control port of the television 44. Preferably this is done in accordance with the technologies and protocols described above in connection with step 176 of the first exemplary method 169. Alternatively, an input of the television may directly receive an Internet or network line or a television tuner card in the computer may be substituted for a stand-alone television. In any event, as step 216 indicates, if connection has not yet been established, desirably an alert is provided to the user, such as an on-screen pop-up or display window, instructing the user to first connect the set to the site and then to operate the Help function. As step 218 indicates, the exemplary method 210 then restarts.

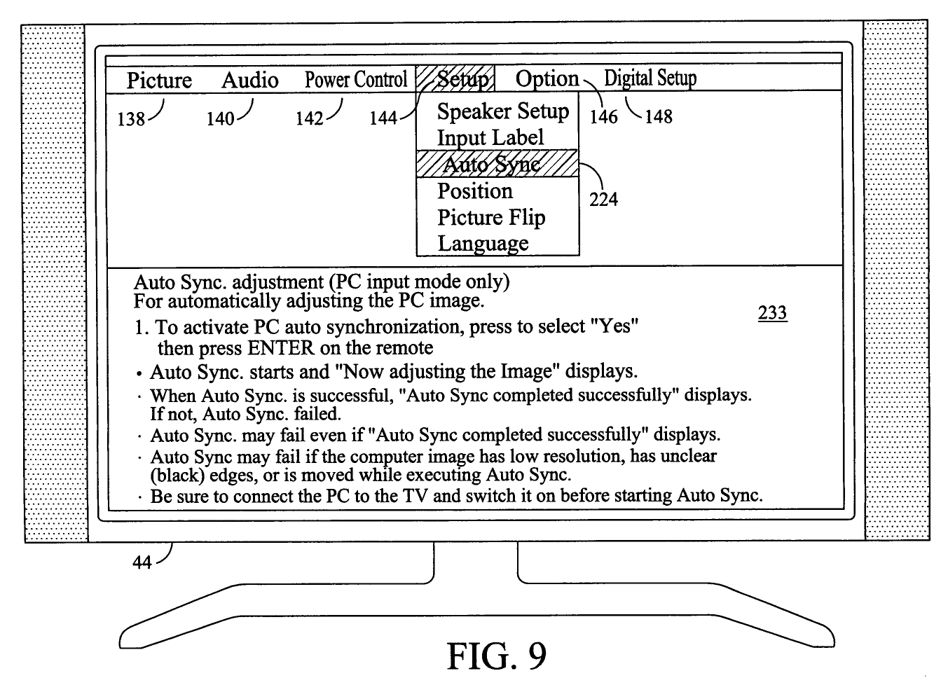

If, on the other hand, the set 24 is already connected to the support site when the Help function is selected, as step 220 indicates, the next step is determining whether the user highlighted an on-screen menu item of interest (e.g., either under control of the handheld remote 26 or personal computer 60) before selecting the Help function. If so, continuing to step 222, the latest update of the explanation on how this on-screen menu item operates is immediately retrieved from the central database 34 (FIG. 1) and displayed on the set. FIG. 9 shows this explanation screen 233 as it appears on the display of television 44 when, prior to selecting the Help function, the drop-down menu item of interest “Auto Sync” 224 was highlighted (either with a personal computer and mouse or with the Menu- and Navigational-entry buttons, 136 and 150, on the handheld remote). Otherwise, if the user did not indicate, by highlighting, any on-screen menu item of interest prior to selecting the Help function, then as step 226 indicates, desirably an image 228 representing the current control device (of the handheld remote) is displayed on the set together with a suitable label 230, such as “Remote Help” (note that if the current control is the personal computer, an on-screen menu item representing the controls of that computer would appear). In either case, the user is clearly alerted that the Help function is successfully activated.

If the user is satisfied with the explanation given and wishes to stop at this point, as step 232 indicates, he or she only needs to select the Help function a second time. The special control functionality enabled under the exemplary method 210 then ceases and normal functioning of the entry items resumes. This step is repeated after the selection of each entry item thereby affording the user the opportunity to discontinue the method at any time.

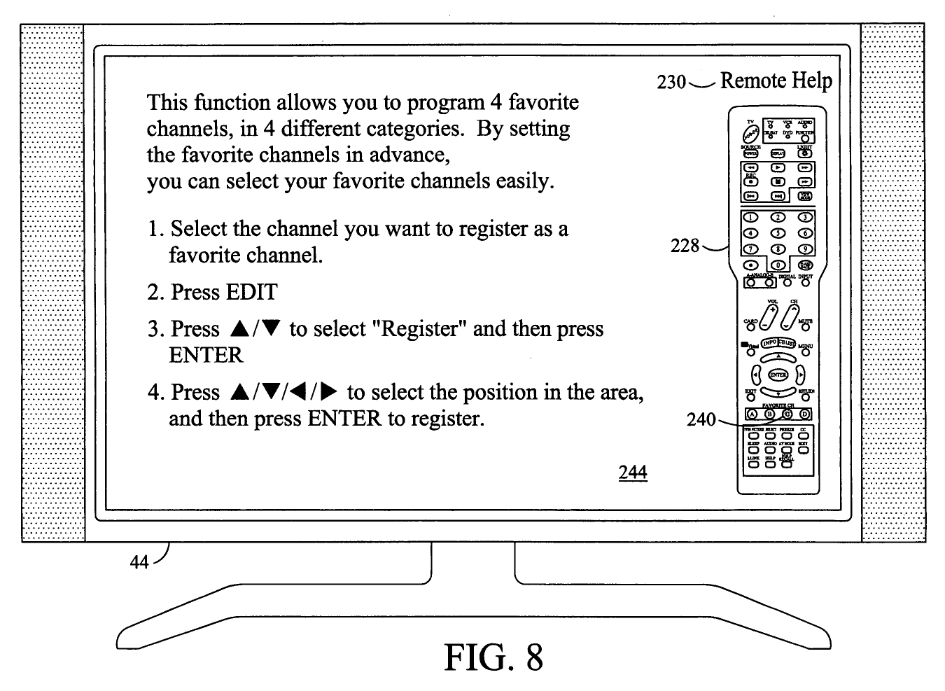

If the user wishes to continue, they can select a different entry item of interest and retrieve its explanation either by highlighting a different on-screen menu item, as indicated by step 234, or by selecting an entry item using any other means, as indicated by step 236, such as by pressing an entry button on the remote control 60 that is of interest to the user but that is not associated with Menu control (if necessary, by first pressing the Exit button 154 to leave the Menu mode). In the former step, where the entry can be selected using either the handheld remote 26 or a mouse device of the personal computer 60, the process reverts back to step 222 and the type of screen display resulting is shown in FIG. 9. In the latter step, on the other hand, the personal computer is not available as a control device, and a different type of screen display results, as shown in FIG. 8.

Referring to FIG. 8, as indicated by step 238, an image 228 of the current control device, that is, of the handheld remote 26, is displayed, if not displayed already. This image may already be displayed from step 226, it may already have been displayed and lost because the last selection was of an on-screen menu item (e.g., using Menu mode), or it may never have been displayed previously because every intervening selection was of an on-screen menu item. As step 238 and FIG. 8 further indicate, on this image 228 of the current control device, the entry item or button of interest that was actually selected by the user is preferably highlighted (here by darkening virtual button 240 corresponding to that one of the Favorite Channel buttons 158 labeled “C,” see FIG. 3). Such highlighting can be performed in any visually obvious manner including, for example, by differently coloring, outlining, enlarging, brightening, or causing the blinking of the selected button. This visually confirms for the user which entry button of interest is actually selected, that is, the user will immediately be alerted if they thought they had selected one button but actually selected another. As step 242 and FIG. 8 moreover indicate, the latest update available of the explanation on how the selected entry item of interest operates is retrieved from the central database and displayed, here as an explanation screen 244.

From this step forward, as FIG.6 suggests, the process of selecting different entry items of interest and displaying the latest explanation available on how each entry operates can be repeated as many times as desired. Or, as indicated in step 232 and mentioned above, the user has only to select the Help function a second time to quit the second exemplary method 210.

It will be evident to those of ordinary skill in the art that at least certain substitutions and combinations other than those set forth above in compliance with the requirement of describing the best mode for practicing the invention are possible and could be employed to alter the particular structures and operations described without, in fact, significantly deviating from the core teachings and essential elements of the present invention. It will be particularly noted that the terms and expressions employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A method for helping a user operate a media-playing set using a control device comprising:
(a) providing a support site for supporting said user and other users, said support site being located remotely from and selectively connectible electronically to the respective set of each user and being staffed by at least one representative;
(b) as said representative is helping said user, displaying an on-screen image representing said control device on said set; and
(c) as said representative remotely makes different entries for configuring said set, highlighting the respective entry items on said image corresponding to said entries remotely made by said representative.

2. The method of claim 1 further including remotely displaying an on-screen replica of said control device designed for interactive operation by said representative such that as said representative remotely makes different entries on said replica, the corresponding entry items on said image are highlighted.

3. The method of claim 1 further including displaying said image superimposed over a content screen and updating both said image and said content screen as said representative remotely makes different entries.

4. The method of claim 1 wherein said control device is a first control device and said image is a first on-screen image and further including simultaneously displaying a second on-screen image representing a second control device and highlighting entry items on both said first- and second-on-screen images as said representative makes different entries for configuring said set.

5. The method of claim 1 further including highlighting the respective entries on said image in a manner selected from the group consisting of coloring, outlining, enlarging, brightening, and blinking.

6. A system for helping a user operate a media-playing set using a control device comprising:
(a) a support site for supporting said user and other users, said support site being located remotely from and selectively connectible electronically to the respective set of each user and including a central database, and
(b) said control device including a help function configured so that, upon user selection of said help function, an explanation on how a selected entry item of interest operates is retrieved from said central database and is displayed by said set.

7. The system of claim 6 wherein said entry item of interest is selected by said user pressing an entry button of interest on said control device after selecting said help function.

8. The system of claim 6 wherein said control device is a handheld remote control.

9. The system of claim 6 wherein said control device is a personal computer.

10. The system of claim 6 wherein an instruction manual is available for said set containing a section explaining how each entry item operates and said explanation retrieved from said central database is substantially as comprehensive in detail as said section for the corresponding entry item.

11. A method for helping a user operate a media-playing set using a control device comprising:
(a) providing a support site for supporting said user and other users, said support site being located remotely from and selectively connectible electronically to the respective set of each user and including a central database; and
(b) providing a help function on said control device and, upon user selection of said help function, retrieving an explanation from said central database on how a selected entry item of interest operates and displaying said explanation on said set.

12. The method of claim 11 further including said user selecting said entry item of interest on said control device after selecting said help function.

13. The method of claim 12 further including selecting said entry item of interest using a handheld remote control.

14. The method of claim 12 further including selecting said entry item of interest using a mouse device of a personal computer.

15. The method of claim 11 further including displaying an image representing the control device on said set and highlighting said selected entry item of interest.

16. The method of claim 15 further including highlighting said entry item of interest in a manner selected from the group consisting of coloring, outlining, enlarging, brightening, and blinking.

17. The method of claim 11 further including enabling said user to resume normal functioning of said entry items by selecting said help function a second time.

18. The method of claim 11 further including revising said explanation by updating said central database.

19. The method of claim 1 wherein said user may recall previous entry sequences made by said representative.

20. The method of claim 1 wherein said media-playing set and said support site are interconnected by a computer network.

21. The method of claim 1 wherein said media-playing set is a television.

22. The method of claim 6 wherein said media-playing set and said support site are interconnected by a computer network.

23. The method of claim 6 wherein said media-playing set is a television.

24. The method of claim 11 wherein said media-playing set and said support site are interconnected by a computer network, said media-playing set is a television, and said capture device is a handheld remote control.

25. The method of claim 21 wherein said control device is a handheld remote.

26. The method of claim 23 wherein said control device is a handheld remote.
